(19) United States
(12) Patent Application Publication
(10) Pub. No.: US 2015/0095488 A1
(43) Pub. Date: Apr. 2, 2015

(54) SYSTEM AND METHOD FOR ACQUIRING LOG INFORMATION OF RELATED NODES IN A COMPUTER NETWORK

(71) Applicant: FUJITSU LIMITED, Kawasaki-shi (JP)

(72) Inventor: Yoshinori Sutou, Kawasaki (JP)

(73) Assignee: Fujitsu Limited, Kawasaki (JP)

(21) Appl. No.: 14/456,170

(22) Filed: Aug. 11, 2014

(30) Foreign Application Priority Data
Sep. 27, 2013 (JP) 2013-202652

(51) Int. Cl. H04L 12/26

(52) U.S. Cl. CPC H04L 43/065; H04L 43/0876
USPC 709/224

(57) ABSTRACT

A system includes a plurality of apparatuses, each including a plurality of resources and a processor. The apparatus acquires an operation history of at least one resource among the plurality of resources, and monitors a state of the at least one resource among the plurality of resources. The apparatus notifies other apparatuses physically or logically associated with the apparatus of first control information when the state of the monitored at least one resource exceeds a threshold value, and increases a degree of detail for the acquired operation history when the state of the at least one resource exceeds the threshold value or second control information is notified from the other apparatuses.

### CROSS-REFERENCE TO RELATED APPLICATION

This application is based upon and claims the benefit of priority from the prior Japanese Patent Application No. 2013-202652 filed on Sep. 27, 2013, the entire contents of which are incorporated herein by reference.

### FIELD

Exemplary embodiments of the present disclosure are related to a system and method for acquiring log information of related nodes in a computer network.

### BACKGROUND

When a fault has occurred in an information processing apparatus, an investigation into the cause of the fault is performed by interpreting a file in which various information are stored. Files used in the investigation into the cause of the fault may include the following files. For example, a file called a system log file in which a log message of Operating System (OS) or an application is archived is used. Further, a file in which system information for, for example, a Central Processing Unit (CPU), network, memory, and disk are regularly collected is also used. Furthermore, a file called an OS dump file in which contents of a memory or register when the OS is abnormally terminated is also used.

Information as detailed as possible are stored in various files used for investigating into the cause of the fault to make the investigation into the cause easy. Hereinafter, information used for investigating into the cause of the fault is referred to as “log information”.

However, when the log information is collected in detail, the size of various files that store the log information increases and thus, the consumption of the disk space increases or the time taken to investigate the contents of file increases. Further, as the log information is recorded in detail, the number of times the file storing information is accessed increases, and computing resources, such as the CPU, disk, or memory, decrease.

The following technique has been proposed as a technique of adjusting the degree of detail for acquiring log information. For example, there is a conventional technique in which variation status of resource use rate in the information processing system is monitored and a monitoring interval is dynamically changed depending on the variation of the resource use rate. Further, there is a conventional technique in which each node, such as an information processing apparatus connected to a network, collects information including the amount of memory in use to determine whether the operation state of its own device is normal and when it is determined that the operation state is in an abnormal condition, the operation monitoring information is transmitted to other nodes. Further, there is a conventional technique in which the degree of detail of the log information is increased when abnormality has occurred in a communication counterpart among a plurality of information processing apparatuses that communicate with each other.

See, for example, Japanese Patent Laid-Open Publication No. 2005-4336, Japanese Patent Laid-Open Publication No. 2009-199246 and Japanese Patent Laid-Open Publication No. 2010-286889.

### SUMMARY

According to one aspect of the invention, a system includes a plurality of information processing apparatuses. Each of the information processing apparatuses includes a plurality of resources; acquires an operation history of at least one resource among the plurality of resources; monitors a first state of the at least one resource among the plurality of resources; notifies other information processing apparatuses physically or logically associated with the each information processing apparatus of first control information when the first state of the monitored at least one resource exceeds a threshold value; and increases a degree of detail for the acquired operation history when the first state of the at least one resource exceeds the threshold value or second control information is notified from the other information processing apparatuses.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a parallel computer system, according to an embodiment.

FIG. 2 is a diagram illustrating an example of a functional configuration of a computation node, according to an embodiment.

FIG. 3 is a diagram illustrating an example of a log level, according to an embodiment.

FIG. 4 is a diagram illustrating an example of an operational flowchart for a log level change process, according to an embodiment.

FIG. 5 is a diagram illustrating an example of a configuration of a parallel computer system, according to an embodiment.

FIG. 6 is a diagram illustrating an example of a configuration of a parallel computer system, according to an embodiment.

FIG. 7 is a diagram illustrating an example of a configuration of a parallel computer system, according to an embodiment.

FIG. 8 is a diagram illustrating an example of a hardware configuration of a computation node, according to an embodiment.

FIG. 9 is a diagram illustrating an example of a hardware configuration of an I/O node, according to an embodiment.

### DESCRIPTION OF EMBODIMENTS

For example, an information processing system such as a parallel computer system is used in the field of a High Performance Computing (HPC). In the parallel computer system, a single information processing system includes a plurality of computation nodes serving as information processing apparatuses. Also, each computation node may be operated by being associated with adjacent computation nodes. Therefore, in the parallel computer system, when investigating the cause of the fault, the investigation into the cause of the fault is frequently performed in such a manner that, in addition to the problematic computation node, the log information of a computation node that is operated in cooperation with the problematic computation node, such as a computation node adjacent to the problematic computation node, is also examined.

However, in the conventional log information acquisition method, it is difficult to appropriately change the degree of detail for collecting the log information depending on the load of the system, in corporation with each other among a plurality of computation nodes. For example, the conventional technique in which the monitoring interval is dynamically changed depending on the variation of the resource use rate is intended for a single computing device and does not take into account the cooperation among the plurality of computation nodes. Therefore, even when the conventional technique is utilized, it is difficult to control the acquisition of log information associated with the plurality of computation nodes.

Further, even when the conventional technique in which the operation monitoring information is transmitted to other computation node is used in a case where it is determined that abnormality has occurred in each computation node, it is difficult to control the acquisition of the log information of a computation node other than the computation node in which abnormality has occurred. Further, even when the conventional technique is utilized in which the degree of detail of the log information is increased in a case where abnormality has occurred in a communication counterpart, although it is possible to control the communication counterpart, it is difficult to conduct a control for a computation node which performs relevant processing.

Hereinafter, descriptions will be made on exemplary embodiments of the information processing system, the control method of the information processing system, and the control program of the information processing apparatus disclosed in the present disclosure with reference to accompanying drawings in detail. Further, the information processing system, the control method of the information processing system, and the control program of the information processing apparatus disclosed in the present disclosure is not limited to the exemplary embodiments.

### Embodiment 1

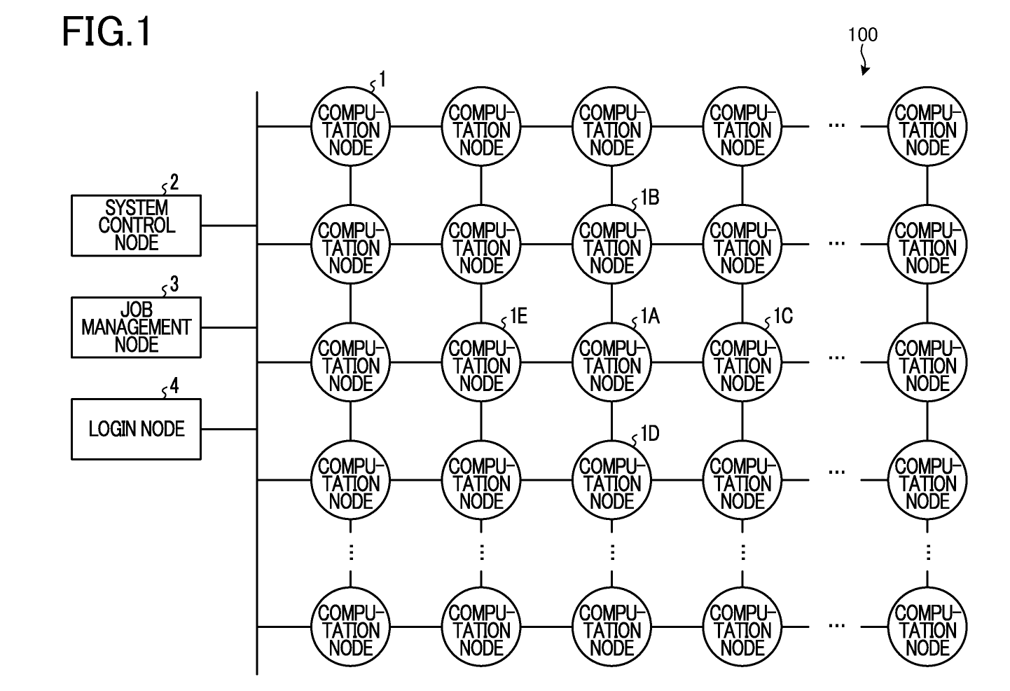

FIG. 1 is a diagram illustrating an example of an overall configuration of a parallel computer system, according to an embodiment. Descriptions will be made using a parallel computer system 100 as an information processing system in the present embodiment. The parallel computer system 100 according to the present embodiment includes a computation node 1, a system control node 2, a job management node 3 and a login node 4. For example, the computation nodes 1 are disposed to form a two-dimensional mesh network structure as illustrated in FIG. 1 in the present embodiment.

Here, the computation nodes 1 form the two-dimensional mesh network structure in the embodiment, but the nodes may form other network structure. Hereinbelow, when a plurality of the computation nodes 1 are collectively indicated, the computation nodes 1 are referred to as a “computation node group”. The computation node corresponds to an example of an “information processing apparatus”.

The system control node 2 performs a comprehensive and general management, such as the software configuration management, in the operation of the computation node 1.

The job management node 3 is operated by a job manager which is a job management software.

The job manager receives a job document from the login node 4 and receives a request for job execution. An operation that the job manager receives a request for job execution by the reception of the job document input from a user may be called “a job input”. When a job is input, the job manager interprets the job document to acquire a job execution condition such as the number of computation nodes 1 used in the job. Also, the job manager performs a job scheduling including determining of a computation node 1 to which the job is allocated.

Here, in the computation node 1, the job manager daemon which is a process that receives instruction of the job manager to perform a job management processing is always being activated. When requirements of the computation node group to be used are secured and a job execution condition is satisfied, the job manager instructs the job management daemon of the computation node group to execute the job to perform allocating jobs to the computation node group as well as instructing the computation node group to execute the job.

When execution of an application is completed in the job management daemon, the job manager receives notification of an end state. Also, after transmission of the result is performed by the job manager, the parallel computer system 100 ends the job execution.

The login node 4 receives input of the job document, in which the job execution condition is described, from a user of the parallel computer system 100. Also, the login node 4 transmits the acquired job document to the job management node 3. Particulars, such as a file path of an application which is an execution target for instruction issued by the user and the number of computation nodes 1 required for execution of the application, are described in the job document.

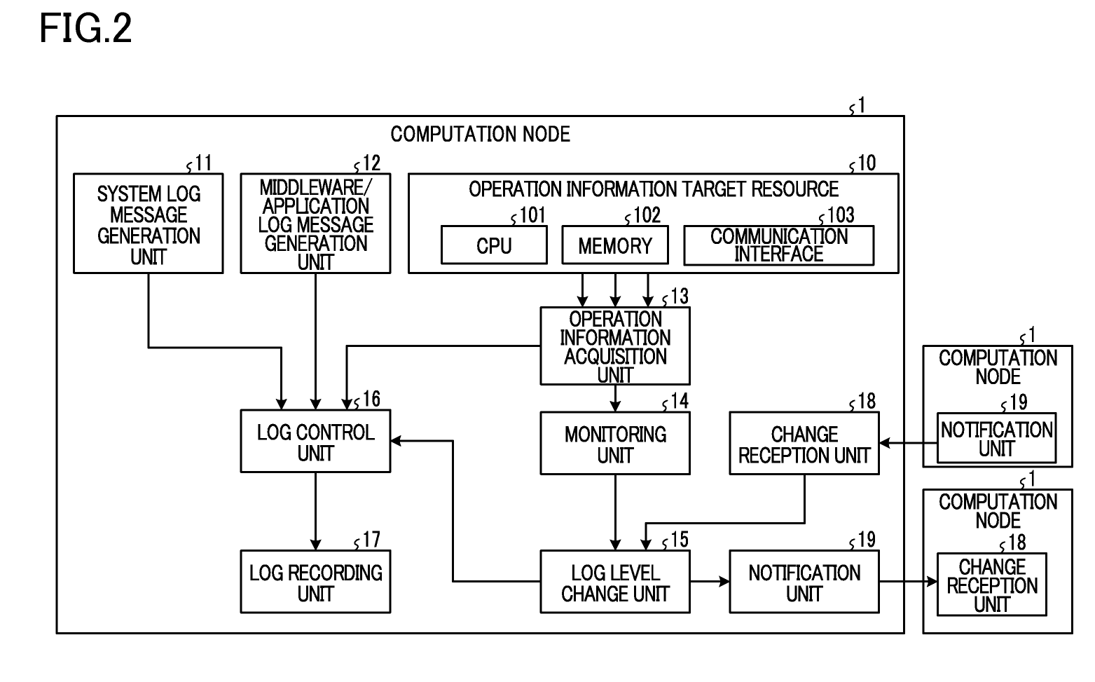

Next, the computation node 1 will be described with reference to FIG. 2. FIG. 2 is a diagram illustrating an example of a functional configuration of a computation node, according to an embodiment. As illustrated in FIG. 2, the computation node 1 includes an operation information target resource 10, a system log message generation unit 11, and a middleware/application log message generation unit 12. Further, the computation node 1 includes an operation information acquisition unit 13, a monitoring unit 14, a log level change unit 15, a log control unit 16, a log recording unit 17, a change reception unit 18, and a notification unit 19.

The operation information target resource 10 includes, for example, a CPU 101, a memory 102, and a communication interface 103. The CPU 101, the memory 102, and the communication interface 103 execute the job allocated from the job manager which operates on the job manager node 3.

The CPU 101 and the memory 102 execute the job allocated from the job management node 3. Further, the communication interface 103 is an interface of an interconnect that connects the computation nodes 1 with each other. The CPU 101 communicates with another CPU 101 of other computation node 1 via the communication interface 103 and the interconnect connected thereto.

The system log message generation unit 11 creates a system log message including, for example, start and end information of the computation node 1, hardware recognition and initialization process information, or OS error information.

The middleware/application log message generation unit 12 creates a middleware/application log including, for example, start and end information of a middleware/application or error information in the middleware/application.

The operation information acquisition unit 13 acquires the operation information of the CPU 101, the memory 102, and the communication interface 103. The operation information acquisition unit 13 acquires, for example, use rate of the CPU 101 as the operation information of the CPU 101. Further, the operation information acquisition unit 13 acquires, for example, use rate of the memory 102 as the operation information of the memory 102. Further, the operation information acquisition unit 13 acquires, for example, use rate of the interconnect as the operation information of the communication interface 103. Furthermore, the operation information acquisition unit 13 acquires, for example, the amount of OS jitter from the CPU 101 and the memory 102 that operate the OS, as the operation information. Here, the OS jitter indicates an interrupt of a process or a switch that occurs during execution of a computation processing by the OS, meaning that the computation processing is stopped.

The monitoring unit 14 acquires the operation information of the resource, which is designated by the operator, from the operation information acquisition unit 13. In the embodiment, a case where the monitoring unit 14 acquires the use rate of the memory 102 from the operation information acquisition unit 13 will be described.

The monitoring unit 14 compares a threshold value of the use rate of the memory 102 designated by the operator with the use rate of the memory 102 acquired from the operation information acquisition unit 13. Also, when the use rate of the memory 102 is the threshold value or more, the monitoring unit 14 notifies the log level change unit 15 of excess of the threshold value.

Next, the monitoring unit 14 acquires the operation information from the operation information acquisition unit 13 again, after a predetermined time has elapsed after notifying the log level change unit 15 of excess of the threshold value. Then, the monitoring unit 14 compares the threshold value of the use rate of the memory 102 with the use rate of the memory 102 acquired again from the operation information acquisition unit 13. When the use rate of the memory 102 acquired again is lower than the threshold value, the monitoring unit 14 notifies the log level change unit 15 of decrease of load.

The log level change unit 15 performs notification of change of the log level used for collecting the log information by the log control unit 16. Here, the log information is information used for investigating into the cause of the fault, and the log level corresponds to a degree of detail of information to be collected. Also, increasing the log level corresponds to changing the degree of detail so as to collect the log information in more detail. Hereinbelow, the log level change unit 15 will be described in detail.

When changing a log level of an own device, the log level change unit 15 stores in advance information on a target computation node 1 of which log level is to be changed simultaneously. The target computation node 1 to be changed is a computation node which is physically or logically associated with the own device. In the embodiment, the log level change unit 15 stores information on the computation node 1 of which communication line is directly connected to the own device, as the information on a target computation node 1 to be changed. The computation node 1 of which communication line is directly connected to the own device corresponds to computation nodes 1B, 1C, 1D, and 1E in the case where the computation node 1A in FIG. 1 is set as an own device. Hereinbelow, the computation node 1 of which communication line is directly connected to the own device is referred to as an “adjacent node”.

When the notification of excess of the threshold value is received from the monitoring unit 14, the log level change unit 15 transmits notification of increasing a log level to a value predetermined for acquiring detailed log information, to the log control unit 16. In this case, the log level change unit 15 instructs the notification unit 19 to notify the adjacent node of the increase of the log level.

When notification of decrease of load is received from the monitoring unit 14 after performing the notification of increase of the log level according to instruction from the monitoring unit 14, the log level change unit 15 transmits notification of return of the log level to a predetermined initial value to the log control unit 16. Additionally, the log level change unit 15 instructs the notification unit 19 to notify the adjacent node of the return of log level. Notification of “increase of log level” and “return of log level” transmitted to the adjacent node through the notification unit 19 by the log level change unit 15 correspond to an example of control information.

Further, the log level change unit 15 receives notification of the increase of the log level, which is transmitted from the notification unit 19 of other computation node 1, from the change reception unit 18. Also, when the notification of the increase of the log level is received, the log level change unit 15 transmits notification of increase of the log level to a predetermined log level to the log control unit 16.

When the notification of return of the log level is received from the change reception unit 18 after performing notification of increase of the log level according to instruction from other computation node 1, the log level change unit 15 returns the log level to the predetermined initial value.

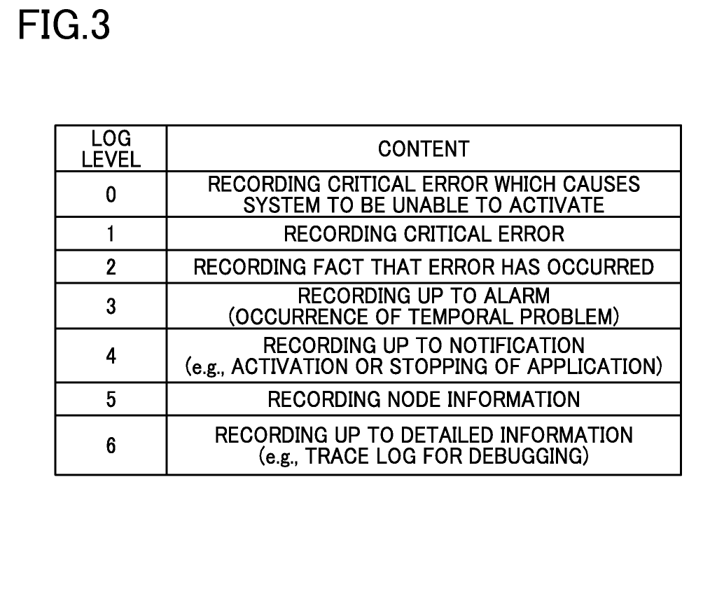

Here, the log level will be described in detail with reference to FIG. 3. FIG. 3 is a diagram illustrating an example a log level, according to an embodiment.

As illustrated in FIG. 3, in the embodiment, the degree of detail used for collecting the log information is classified into seven stages of a log level. In the log level illustrated in FIG. 3, the smaller the value of the log level, the lesser the log information to be collected. That is, the log information becomes less detail as the value of the log level becomes smaller. For example, in a state where the log level is “1”, only information indicating a significant error or more is written, but in a state where the log level is “4”, information indicating notification, such as to information on start or stopping of application, is also written. That is, increasing the log level corresponds to making the value of the log level in FIG. 3 larger.

For example, operations of the log level change unit 15 will be explained for a case where the initial value of the log level is set at 1 (one) and the log level for acquiring the detailed log information is set at 4 (four). After the computation node 1 is started, the log control unit 16 (to be described below) collects the log information with keeping the degree of detail at the log level of 1 (one). Upon receiving the notification of excess of the threshold value from the monitoring unit 14, the log level change unit 15 transmits instruction to change the log level from 1 (one) to 4 (four), to the log control unit 16. Further, the log level change unit 15 transmits instruction to change the log level of the adjacent node from 1 (one) to 4 (four), to the notification unit 19. Thereafter, upon receiving the notification of decrease of load from the monitoring unit 14, the log level change unit 15 transmits instruction to return the log level from 4 (four) to 1 (one), to the log control unit 16. Further, the log level change unit 15 transmits instruction to return the log level of the adjacent node from 4 (four) to 1 (one), to the notification unit 19.

Here, in the embodiment, descriptions have been made for a case where the change of log level is performed using two types of log levels set in advance, but the change of log level is not limited thereto and the log level change unit 15 may provide instructions to change a log level among two or more types. For example, the following method may be considered. The monitoring unit 14 includes a plurality of threshold values. Also, the monitoring unit 14 notifies the log level change unit 15 of a threshold value that is exceeded. The log level change unit 15 stores log levels in association with each threshold value, and notifies the log control unit 16 of instruction to change the log level to a log level associated with the threshold value notified from the monitoring unit 14.

In addition, upon receiving instruction to change the log level from the monitoring unit 14, the log level change unit 15 may transmit a notification of increase of the log level by 1 (one) stage, to the log control unit 16. In this case, upon receiving a notification of return of the log level from the monitoring unit 14, the log level change unit 15 may transmit a notification of decrease of the log level by 1 (one) stage, to the log control unit 16. Further, upon receiving instructions to change the log level plural times from the monitoring unit 14 for every predetermined period of time, the log level change unit 15 may increase the log level sequentially in conformity with the reception times of the instruction.

After the computation node 1 is started, the log control unit 16 collects the log information from the system log message generation unit 11, the middleware/application log message generation unit 12, and the operation information acquisition unit 13, with the log level having a predetermined initial value.

Thereafter, upon receiving the notification of increase of the log level from the log level change unit 15, the log control unit 16 changes setting of the log level to a predetermined log level. Also, the log control unit 16 collects the log information from the system log message generation unit 11, the middleware/application log message generation unit 12, and the operation information acquisition unit 13, with the log level being increased.

Further, when the notification of return of the log level is received from the log level change unit 15 after increasing the log level, the log control unit 16 returns the setting of the log level to the initial value. Also, the log control unit 16 collects, with the log level having been returned to the initial value, log information from the system log message generation unit 11, the middleware/application log message generation unit 12, and the operation information acquisition unit 13.

The log control unit 16 sends the collected log information to the log recording unit 17.

The log recording unit 17 records the log information received from the log control unit 16 into the storage device. For example, the log recording unit 17 writes the log information into a storage area of the system control node 2. Further, the log recording unit 17 may write the log information into the storage device such as the memory 102 of the own device.

The operator performs the investigation into the cause of the fault using the log information recorded by the log recording unit 17. For example, the operator performs the investigation into the cause of the fault by using the log information written by the log recording unit 17 of each computation node 1 and stored in the system control node 2.

When the use rate of the memory 102 becomes the threshold value or more in the adjacent node, the change reception unit 18 receives the notification of increase of the log level from the notification unit 19 of the adjacent node. Then, the change reception unit 18 sends the received notification of increase of the log level to the log level change unit 15.

Further, when receiving the notification of return of the log level from the notification unit 19 of the adjacent node after receiving the notification of increase of the log level from the adjacent node, the change reception unit 18 sends the notification of return of the log level to the log level change unit 15.

When the use rate of the memory 102 becomes the threshold value or more in the own device, the notification unit 19 receives, from the log level change unit 15, instruction to notify the adjacent node of increase of the log level. Then, the notification unit 19 transmits the notification of increase of the log level to the adjacent node.

Further, when the use rate of the memory 102 becomes less than the threshold value after the use rate of the memory 102 has become the threshold value or more in the own device, the notification unit 19 receives, from the log level change unit 15, instruction to notify the adjacent node of return of log level. Then, the notification unit 19 also transmits the notification of return of the log level to the adjacent node.

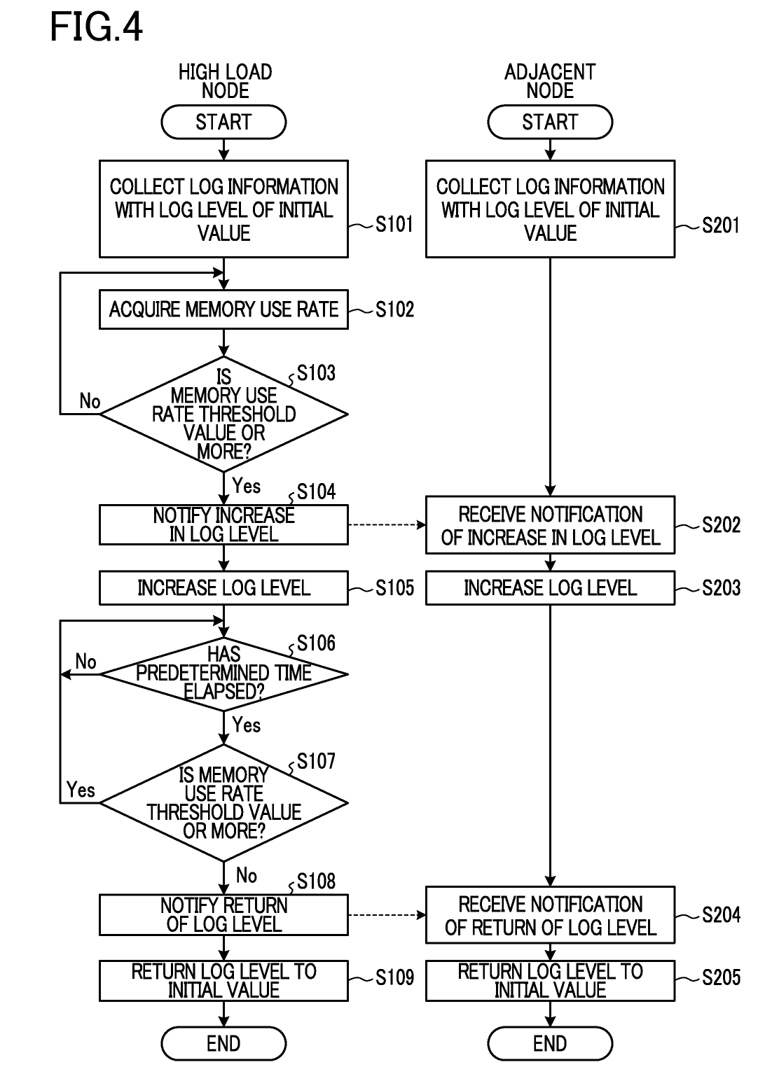

Next, descriptions will be given of a flow of a log level change process in parallel computer system, according to an embodiment with reference to FIG. 4. FIG. 4 is a diagram illustrating an example of an operational flowchart for a log level change process in an information processing system, according to an embodiment. The flowchart at the left side of FIG. 4 indicates a process performed by a high load node that is a computation node 1 of which the use rate of the memory 102 has exceeded the threshold value. Further, the flowchart at the right side of FIG. 4 indicates a process performed by another computation node 1 which is an adjacent node of the high load node. Further, a dotted line with an arrow head directing from the left flowchart to the right flowchart of FIG. 4 indicates that notification from the high load node to the adjacent node is performed at the time when the operation connected with the dotted line is performed.

First, a process performed by the high load node will be described. After being started up, the log control unit 16 collects, with the log level having an initial value, the log information (step S101). The monitoring unit 14 acquires the use rate of the memory 102 from among the operation information of resources acquired by the operation information acquisition unit 13 (step S102).

Next, the monitoring unit 14 determines whether the acquired use rate of the memory 102 is the threshold value or more (step S103). When it is determined that the use rate of the memory 102 is less than the threshold value (“NO” at step S103), the monitoring unit 14 goes back to step S102 and continues monitoring of the use rate of the memory 102.

In contrast, when it is determined that the use rate of the memory 102 is the threshold value or more (“YES” at step S103), the monitoring unit 14 notifies the log level change unit 15 of excess of the threshold value. The log level change unit 15 notifies the log control unit 16 and the adjacent node of increase of the log level (step S104).

Upon receiving the notification of increase of the log level, the log control unit 16 increases the log level to a predetermined log level (step S105). Then, the log control unit 16 collects, with the log level having been increased, the log information.

The monitoring unit 14 determines whether a predetermined time has elapsed after performing the previous determination for the use rate of the memory 102 (step S106). When it is determined that the predetermined time has not elapsed (“NO” at step S106), the monitoring unit 14 waits until the predetermined time elapses.

In contrast, when it is determined that the predetermined time has elapsed (“YES” at step S106), the monitoring unit 14 determines again whether the use rate of the memory 102 is the threshold value or more (step S107). When it is determined that the use rate of the memory 102 is the threshold value or more (“YES” at step S107), the monitoring unit 14 goes back to step S106.

In contrast, when it is determined that the use rate of the memory 102 is less than the threshold value (“NO” at step S107), the monitoring unit 14 notifies the log level change unit 15 of decrease of load. The log level change unit 15 notifies the log control unit 16 and the adjacent node of return of the log level (step S108).

Upon receiving notification of return of the log level, the log control unit 16 returns the log level to the initial value (step S109). Then, the log control unit 16 collects, with the log level having been returned to the initial value, the log information.

Next, a process performed by the adjacent node will be described. After being started up, the log control unit 16 collects the log information, with the log level of the initial value (step S201).

The change reception unit 18 receives notification of increase of the log level from the high load node. The log level change unit 15 receives the notification of increase of the log level from the change reception unit 18 (step S202). The log level change unit 15 sends the notification of increase of the log level to the log control unit 16.

Upon receiving the notification of increase of the log level, the log control unit 16 increases the log level to the predetermined log level (step S203). Also, the log control unit 16 collects the log information, with the log level having been increased.

Thereafter, the change reception unit 18 receives the notification of return of the log level from the high load node. The log level change unit 15 receives the notification of return of the log level from the change reception unit 18 (step S204). The log level change unit 15 sends the notification of return of the log level to the log control unit 16.

Upon receiving the notification of return of the log level, the log control unit 16 returns the log level to the initial value (step S205). Then, the log control unit 16 collects the log information, with the log level having been returned to the initial value.

As described above, in the information processing system according to the embodiment, the log level of a computation node in which the use rate of the memory becomes the threshold value or more is increased, and the log level of the adjacent node is also caused to be increased. In an information processing system which performs parallel processing in a similar manner to the parallel computer system, adjacent nodes that are directly connected with each other via the network frequently perform interrelated processing. Therefore, if a fault has occurred in any of the computation nodes, the adjacent node may also be affected by the occurrence of the fault. In view of the facts described above, when the investigation of the cause of the fault is performed in the information processing system such as the parallel computer system, not only information on the computation node in which the fault has occurred but information on the adjacent node becomes useful information as well. Accordingly, as in the information processing system according to the embodiment, when load of a computation node is increased, the computation node and the adjacent nodes may be increased so that information useful for the investigation into the cause of the fault is acquired more appropriately. That is, the log level of each of related computation nodes in the information processing system may be appropriately changed according to the load of system, by causing the related computation nodes to cooperate with each other. Accordingly, information of the investigation into the cause of the fault may be efficiently acquired.

Here, the use rate of the memory 102 is used as a reference for measuring increase in load of the computation node 1 in the embodiment. However, operation information of the resource to be monitored as the reference is not limited to the use rate of the memory 102, and the monitoring unit 14 may monitor, as pieces of operation information, for example, use rate of the CPU 101, use rate of the network, or an amount of the OS jitter. Further, the monitoring unit 14 may combine and monitor the above pieces of operation information.

When the use rate of the CPU 101 is used, the monitoring unit 14 determines the load state of the computation node 1, by comparing the use rate of the CPU 101 acquired from the CPU 101 by the operation information acquisition unit 13 with the threshold value.

Further, when the use rate of the network is used, the monitoring unit 14 determines the load state of the computation node 1, by comparing the use rate of the network acquired from the communication interface 103 by the operation information acquisition unit 13 with the threshold value.

Further, when the OS jitter is used, the monitoring unit 14 determines the load state of the computation node 1, by comparing the amount of OS jitter acquired from the CPU 101 and the memory 102 by the operation information acquisition unit 13 with the threshold value.

Further, in the embodiment, description has been made for a case where the change in log level is performed by changing the type of information to be collected, but the change in log level is not limited thereto. For example, when instruction to increase the log level is issued, the log control unit 16 may shorten the collection interval of log information so as to increase the log level. Further, the log control unit 16 may change the log level by combining several changing methods, for example, by combining types of information to be collected and collection times thereof.

### Embodiment 2

Next, the information processing system according to Embodiment 2 will be described. The information processing system according to the embodiment is different from that of Embodiment 1 in that the log levels of all the computation nodes of a computation node group is increased when any one of the computation nodes of the computation node group enters a state of high load. A parallel computer system according to the embodiment is also represented by FIG. 1. Further, a computation node according to the embodiment is also represented by FIG. 2. In the following description, descriptions will be omitted for each component performing the same operation as that of Embodiment 1.

When performing allocation of jobs, the job management node 3 notifies information on a computation node group to which the jobs are to be allocated, to each computation node of the computation node group.

A computation node 1 acquires, from the job management node 3, information on other computation nodes 1 to which the jobs that have been allocated to the computation node group including the own computation node 1 are allocated, that is, information on computation nodes 1 included in the computation node group to which the job performed by the own computation node is allocated. Hereinbelow, information on the computation nodes 1 to which the jobs that have been allocated to the computation node group including the own computation node 1 are allocated, is referred to as “job allocation information”.

Also, when the information on excess of the threshold value is received from the monitoring unit 14, the log level change unit 15 notifies the log control unit 16 of increase in the log level and also, instructs the notification unit 19 to notify other computation nodes 1 indicated by the job allocation information of increase in the log level. That is, the log level change unit 15 instructs the notification unit 19 to notify other computation nodes 1, which are included in the computation node group and to which the job performed by the own device is allocated, of increase in the log level.

Further, when information on the decrease in load is received from the monitoring unit 14, the log level change unit 15 notifies the log control unit 16 of return of the log level and also, instructs the notification unit 19 to notify other computation nodes 1 indicated by the job allocation information of the return of the log level.

Upon receiving the instruction regarding the increase in the log level from the log level change unit 15, the notification unit 19 notifies the other computation nodes 1 indicated by the job allocation information of the increase in the log level.

Upon receiving the instruction regarding the return of the log level from the log level change unit 15, the notification unit 19 notifies the other computation nodes 1 indicated by the job allocation information of the return of the log level.

As described above, in the information processing system according to the embodiment, the computation node of which load is increased increases the log levels of the own computation node and other computation nodes to which the job performed by the own computation node is allocated. The respective computation nodes included in the computation node group to which the job is allocated perform pieces of processing that are associated with each other. Therefore, when a certain fault occurs in a computation node included in the computation node group to which the job is allocated, the influence of the fault may occur on other computation nodes included in the computation node group. Accordingly, as in the information processing system according to the embodiment, when the load of a certain computation node included in the computation node group to which the job is allocated is increased, all the computation nodes included in the computation node group may be increased so that information useful for the investigation into the cause of the fault is acquired more appropriately. That is, the log level of each of computation nodes in the information processing system may be appropriately changed according to the load of system by causing the computation nodes to cooperate with each other. Accordingly, information of the investigation into the cause of the fault may be efficiently secured.

### Embodiment 3

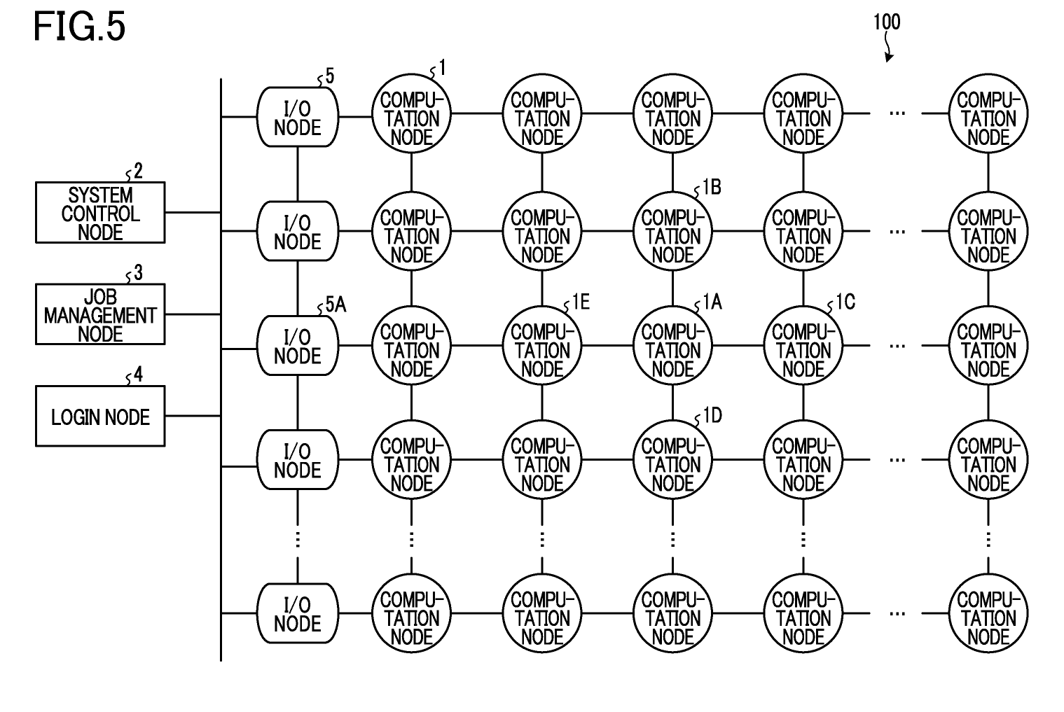

Next, the information processing system according to Embodiment 3 will be described. FIG. 5 is a diagram illustrating an example of a configuration of a parallel computer system according, according to an embodiment. The information processing system according to the embodiment is different from that of Embodiment 1 in that the log level of an Input/Output (I/O) node which relays communications between the computation node and an external apparatus is also increased. Further, the computation node according to the embodiment is represented by FIG. 2. In the following description, descriptions will be omitted for each component performing the same operation as that of Embodiment 1. Further, in the embodiment, descriptions will be made on a case where the I/O node also has the same configuration as that of the computation node.

The parallel computer system according to the embodiment includes I/O nodes 5 in addition to the nodes of Embodiment 1.

The I/O node 5 relays communications between the computation node 1 and an external apparatus, such as a storage device (not illustrated). For example, the computation node 1 may not have a hard disk. In this case, the computation node 1 reads the OS stored in an external storage device through the I/O node 5 to start up. Further, when reading and writing data from and into the external storage device, the computation node 1 performs data reading and data writing via the I/O node 5.

When the information of excess of the threshold value is received from the monitoring unit 14, the log level change unit 15 notifies the log control unit 16 of the increase in the log level and also, instructs the notification unit 19 to notify the I/O node 5, which primarily relays communications of the own computation node and the adjacent nodes thereof, of the increase in the log level. Here, in the embodiment, it is assumed that an I/O node 5, disposed in the same row at which a certain computation node 1 is disposed, primarily relays communications of the computation node 1, in the two-dimensional mesh network structure illustrated in FIG. 5. For example, when the computation node 1A illustrated in FIG. 5 is set as an own computation node, the log level change unit 15 instructs the notification unit 19 to notify the computation nodes 1B to 1E and the I/O node 5A of the increase in the log level.

Further, upon receiving information on decrease in load from the monitoring unit 14, the log level change unit 15 notifies the log control unit 16 of return of the log level and also, instructs the notification unit 19 to notify the I/O node 5, which primarily relays communications of the own computation node and the adjacent nodes thereof, of the return of the log level.

Upon receiving the instruction regarding the increase in the log level from the log level change unit 15, the notification unit 19 notifies the I/O node 5, which primarily relays communications of the own computation node and the adjacent nodes thereof, of the increase in the log level.

The notification unit 19 receives instruction regarding the return of the log level from the log level change unit 15 to notify the I/O node 5, which primarily relays communications of the own computation node and the adjacent nodes thereof, of the return of the log level.

Here, while the embodiment is described based on Embodiment 1, the function that increases the log level of the I/O node 5 may also be added in Embodiment 2 or Embodiment 3.

Further, in the embodiment, when a state of resource is monitored by the I/O node 5 and the state of resource becomes the threshold value or more, the I/O node 5 may also increase the log levels of the I/O node and the computation nodes associated with the own computation node.

In this case, the monitoring unit 14 of the I/O node 5 may monitor the I/O use rate obtained from a state of communication with the external storage, which is acquired from the communication interface 103, as the state of resource.

As described above, in the information processing system according to the embodiment, the computation node of which load is increased increases the log level of the I/O node 5, which primarily relays communications of the own computation node and the adjacent nodes thereof. Since the I/O node relays data reading and data writing when the computation node performs processing, the I/O node and the computation node perform the processing by cooperating with each other. Therefore, when a fault occurs in a certain computation node, the influence of the fault occurrence may occur on the I/O node that primarily relays communications of the computation node. Accordingly, as in the information processing system according to the embodiment, when the load of a computation node is increased, the log level of the I/O node that primarily relays communications of the computation node may be increased so that information useful for the investigation of the cause of the fault is acquired appropriately. That is, the log level of each of nodes in the information processing system may be appropriately changed according to the load of system by causing the computation nodes and the I/O node to cooperate with each other. Accordingly, information of the investigation into the cause of the fault may be efficiently acquired.

### Embodiment 4

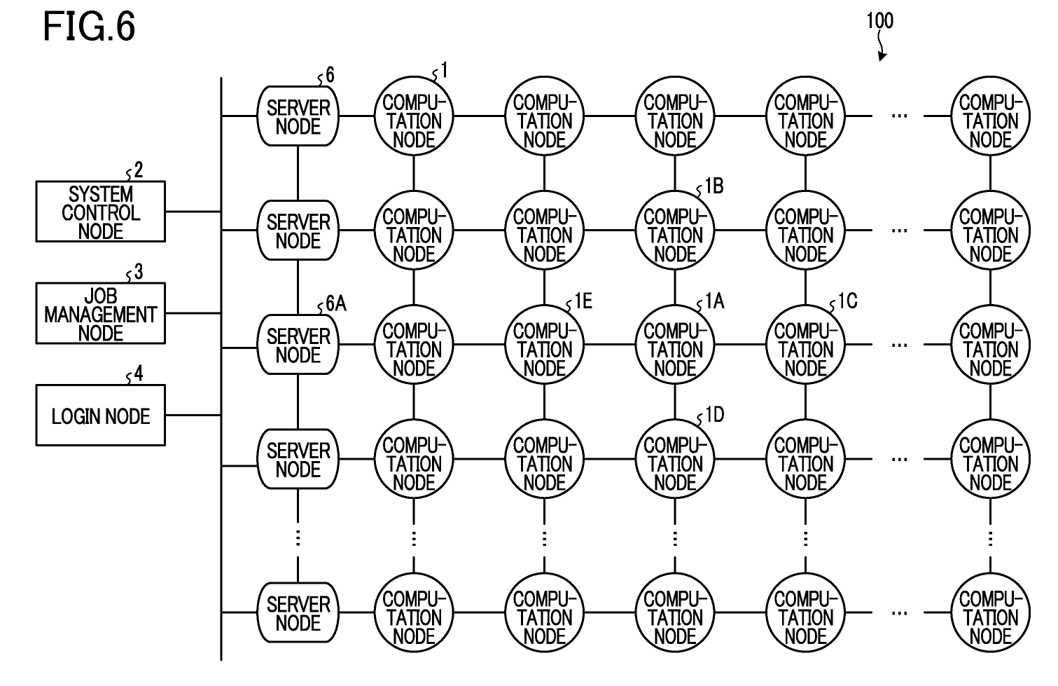

Next, the information processing system according to Embodiment 4 will be described. FIG. 6 is diagram illustrating an example of a configuration of an information processing system, according to an embodiment. The information processing system according to the embodiment is different from that of Embodiment 4 in that the server-client method is used. Further, a computation node according to the embodiment is represented by FIG. 2. In the following description, descriptions will be omitted for each component performing the same operation as that of Embodiment 1.

The information processing system 101 according to the embodiment includes the computation node 1, the system control node 2, the job management node 3, the login node 4, and a server node 6.

The server node 6 is, for example, a gateway server used in a case of performing a network booting. Further, for example, when an OS is read from the external storage device (not illustrated) and activated, the computation node 1 reads the OS through the server node 6A.

When information on excess of the threshold value is received from the monitoring unit 14, the log level change unit 15 notifies the log control unit 16 of the increase in the log level, and also instructs the notification unit 19 to notify the server node 6, which serves as a gateway server for the own computation node and the adjacent nodes thereof, of the increase in the log level. Here, in the embodiment, one of server nodes 6 disposed in the same row at which a certain computation node 1 is disposed, is the server node 6 which primarily relays communications of the certain computation node 1 in the two-dimensional mesh network structure illustrated in FIG. 6. For example, when the computation node 1A illustrated in FIG. 6 is set as an own computation node, the log level change unit 15 instructs the notification unit 19 to notify the computation nodes 1B to 1E and the server node 6A of the increase in the log level.

Further, when the information on the decrease in load is received from the monitoring unit 14, the log level change unit 15 notifies the log control unit 16 of the return of the log level, and also instructs the notification unit 19 to notify the server node 6, which serves as a gateway server for the own computation node and the adjacent nodes thereof, of the return of the log level.

Upon receiving instruction regarding the increase in the log level from the log level change unit 15, the notification unit 19 notifies the server node 6, which serves as a gateway server for the own computation node and the adjacent nodes thereof, of the increase in the log level.

Upon receiving instruction regarding the return of the log level from the log level change unit 15, the notification unit 19 notifies the server node 6, which serves as a gateway server for the own computation node and the adjacent nodes thereof, of the return of the log level.

Here, the embodiment has been described based on Embodiment 1, but the function to increase the log level of the server node 6 may also be provided for Embodiment 2.

As described above, in the information processing system according to the embodiment a server-client system is used, and a computation node of which load is increased increases the log level of a server node 6, which serves as a gateway server for the computation node and the adjacent nodes thereof. Since a server node is operated when a computation node performs processing, the server node and the computation node perform the processing in cooperation with each other. Therefore, when a fault occurs in a certain computation node, the influence of the fault occurrence may occur on the server node serving as a gateway server of the certain computation node. In the case, in the information processing system according to the embodiment, when the load of a certain computation node is increased, the log level of a server node serving as a gateway server of the certain computation node may be increased so that information useful for the investigation into the cause of the fault is acquired more appropriately. That is, the cooperation between the computation node and the server node allows the log level of each computation node in the information processing system to be appropriately changed according to the load of system. Accordingly, information of the investigation into the cause of the fault may be efficiently acquired. Further, the functionalities of each of the above mentioned embodiments may be provided for the information processing system in which a server-client system is used as in this embodiment.

### Embodiment 5

Next, the information processing system according to Embodiment 5 will be described. The information processing system according to the embodiment is different from that of Embodiment 1 in that the information processing system has three-dimensional torus type network structure as a network structure of the computation nodes. The parallel computer system according to the embodiment is also represented by FIG. 1. Further, a computation node according to the embodiment is also represented by FIG. 2. In the following description, descriptions will be omitted for each component performing the same operation as that of Embodiment 1.

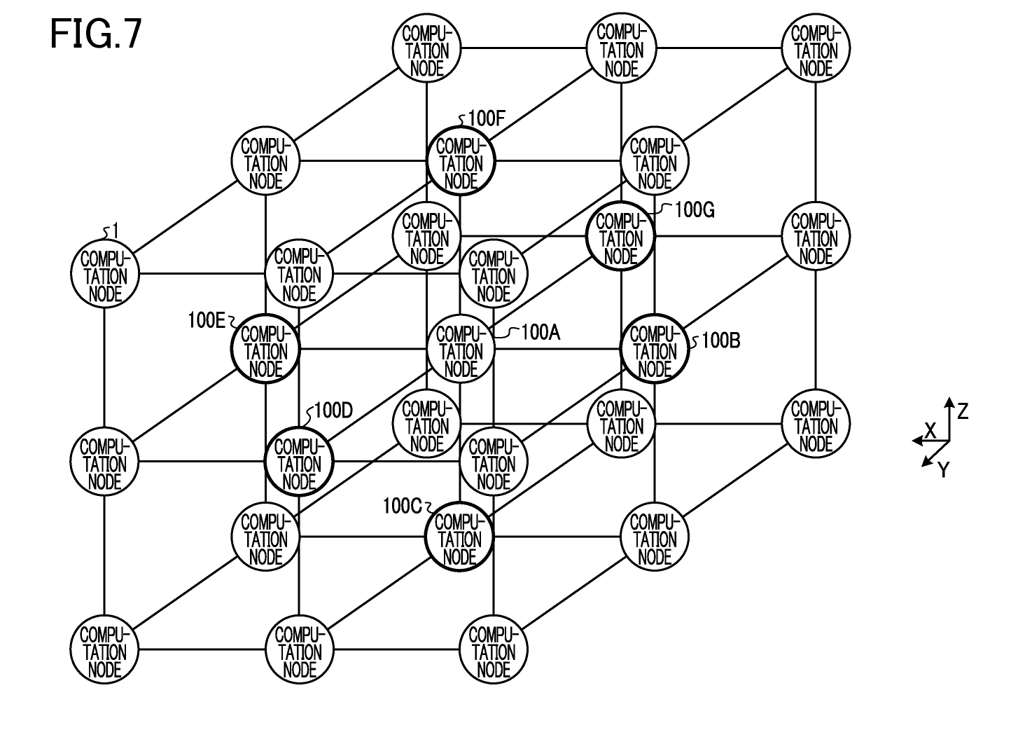

FIG. 7 is diagram illustrating an example of a portion of a network configuration of computation nodes according to Embodiment 5. FIG. 7 illustrates a portion of the computation node group disposed to form the three-dimensional torus type network structure in an enlarged scale.

In the embodiment, computation nodes 1 have a three-dimensional structure, and the computation nodes 1 are disposed, for example, in X, Y, and Z directions as illustrated in FIG. 7. In this case, two computation nodes exist in X direction, two computation nodes exist in Y direction, and two computation nodes exist in Z direction as the adjacent nodes directly connected to a certain computation node.

Accordingly, in the embodiment, the log level change unit 15 stores the computation node 1 of which the communication line is directly connected to the own device as a target adjacent node to be changed. In this case, the adjacent nodes correspond to the computation nodes 100B to 100G in a case where the computation node 100A in FIG. 7 is set as an own device.

Upon receiving information on excess of the threshold value from the monitoring unit 14, the log level change unit 15 notifies the log control unit 16 of the increase in the log level, and, at the same time, instructs the notification unit 19 to notify the notification unit 19 of the increase in the log level. For example, assuming that the computation node 100A illustrated in FIG. 7 is an own computation node, the log level change unit 15 instructs the notification unit 19 to notify the computation nodes 100B to 100G of the increase in the log level.

Further, upon receiving information on decrease in load is received from the monitoring unit 14, the log level change unit 15 notifies the log control unit 16 of return of the log level, and, at the same time, instructs the notification unit 19 to notify the adjacent nodes of the return of the log level.

Upon receiving instruction regarding the increase in the log level from the log level change unit 15, the notification unit 19 notifies the adjacent nodes of the increase in the log level.

Upon receiving instruction regarding the return of the log level from the log level change unit 15, the notification unit 19 notifies the adjacent nodes of the return of the log level.

Here, the embodiment has been described based on Embodiment 1, but the embodiment may be similarly practiced based on Embodiments 2 to 4 by adopting the three-dimensional torus type network structure.

As described above, the information processing system according to the embodiment is a system that adopts a three-dimensional torus type network structure, and a computation node of which load is increased increases the log level of the adjacent nodes thereof in the three-dimensional torus type network structure. As described above, information for the investigation into the cause of the fault may also be efficiently acquired in the information processing system that adopts the three-dimensional torus type network structure.

### Embodiment 6

Next, the information processing system according to Embodiment 6 will be described. The information processing system according to the embodiment is different from that of Embodiment 1 in that the information processing system instructs a virtual adjacent node to increase the log level. The parallel computer system according to the embodiment is also represented by FIG. 1. Further, a computation node according to the embodiment is also represented by FIG. 2. In the following description, descriptions will be omitted for each component performing the same operation as that of Embodiment 1.

The computation node 1 communicates with other computation node 1 by using a virtual adjacency relationship that is set in advance. For example, the computation node 1 is configured to comply with the Message Passing Interface (MPI) communication standard. Also, the computation node 1 stores the virtual adjacency relationship defined by the MPI communication standard. The virtual adjacency relationship indicates a relationship between a certain computation node 1 and a virtual adjacent node with respect to the certain computation node 1. Also, the computation node 1 performs communication by using the virtual adjacency relationship complying with the MPI communication standard.

Upon receiving information on excess of the threshold value from the monitoring unit 14, the log level change unit 15 notifies the log control unit 16 of the increase in the log level, and instructs, at the same time, the notification unit 19 to notify a virtual adjacent node defined in complying with the MPI communication standard of the increase in the log level.

Further, upon receiving information on decrease in load from the monitoring unit 14, the log level change unit 15 notifies the log control unit 16 of the return of the log level, and instructs, at the same time, the notification unit 19 to notify the virtual adjacent node of the return of the log level.

Upon receiving instruction regarding the increase in the log level from the log level change unit 15, the notification unit 19 notifies the virtual adjacent node of the increase in the log level.

Further, upon receiving instruction regarding the return of the log level from the log level change unit 15, the notification unit 19 notifies the virtual adjacent node of the return of the log level.

As described above, the information processing system according to the embodiment is a system that adopts a virtual adjacency relationship defined, for example, in the MPI communication, and a computation node of which load is increased increases the log level of the virtual adjacent node. In the information processing system that adopts the virtual adjacency relationship, communication between the virtual adjacent nodes increases. Therefore, when a fault occurs in a certain computation node, the influence of the fault may occur on the virtual adjacent node. Accordingly, the log level of the virtual adjacent node may be increased to efficiently acquire information useful for the investigation into the cause of the fault in the system that adopts an appropriate virtual adjacency relationship as well.

(Hardware Configuration)

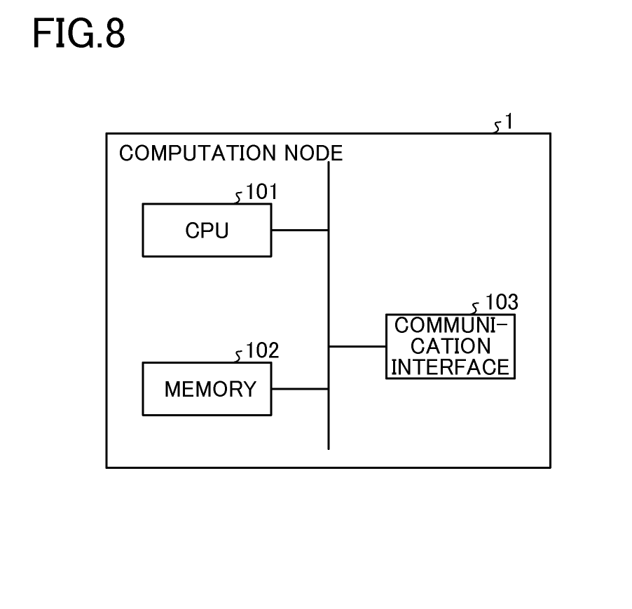

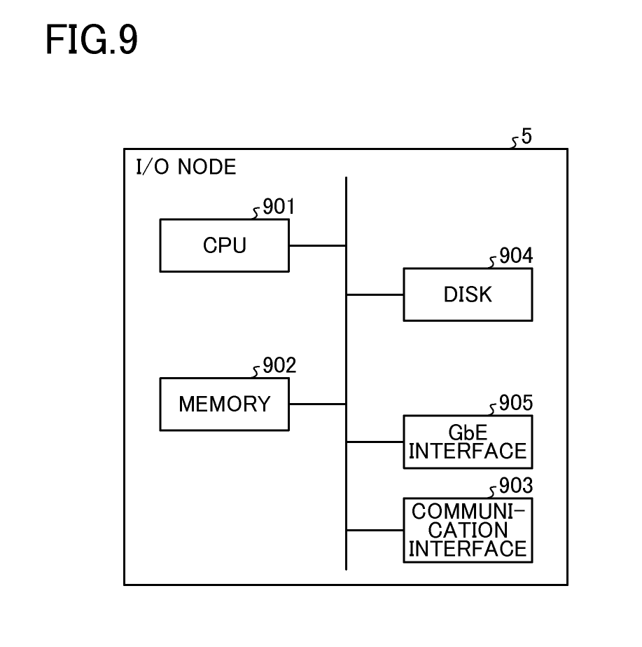

A hardware configuration of the computation node and I/O node will be described with reference to FIG. 8 and FIG. 9. FIG. 8 is a diagram illustrating an example of a hardware configuration of a computation node, according to an embodiment. FIG. 9 is a diagram illustrating an example of a hardware configuration of an I/O node, according to an embodiment.

The computation node 1 includes the CPU 101, the memory 102, and the communication interface 103, as illustrated in FIG. 8.

The CPU 101 and the memory 102 executes jobs and also implement functionalities of the system log message generation unit 11 and the middleware/application log message generation unit 12 illustrated in FIG. 2. Further, the CPU 101 and the memory 102 implement functionalities of the operation information acquisition unit 13, the monitoring unit 14, the log level change unit 15, the log control unit 16, the log recording unit 17, and the change reception unit 18 illustrated in FIG. 2. Furthermore, the CPU 101 and the communication interface 103 implement the functionality of the notification unit 19.

For example, various programs that implement functionalities of the operation information acquisition unit 13, the monitoring unit 14, the log level change unit 15, the log control unit 16, the log recording unit 17, the change reception unit 18, and the notification unit 19 illustrated in FIG. 2 are stored in an external storage device. Also, the CPU 101 reads various programs from the storage device, deploys the programs on the memory 102 as processes, and executes the deployed processes to implement respective functionalities.

Further, the CPU 101 communicates with, for example, other computation node 1 and the I/O node 5, using the communication interface 103.

The I/O node 5 includes a CPU 901, a memory 902, a communication interface 903, a disk 904, and a Gigabit Ethernet (registered trademark) (GbE) interface 905, as illustrated in FIG. 9.

The CPU 901 communicates with the communication interface 103 of the computation node 1 by using the communication interface 903. Further, the CPU 901 communicates with the external storage device by using the GbE interface 905.

Further, when the I/O node 5 performs change in the log level in a manner similar to that performed by the computation node 1, the CPU 901 and the memory 902 implement the functionalities of the system log message generation unit 11 and the middleware/application log message generation unit 12 illustrated in FIG. 2. Further, the CPU 901 and the memory 902 implement the functionalities of the operation information acquisition unit 13, the monitoring unit 14, the log level change unit 15, the log control unit 16, the log recording unit 17, and the change reception unit 18 illustrated in FIG. 2. Further, the CPU 901 and the memory 902 implement the functionality of the notification unit 19.

For example, various programs that implement functionalities of the operation information acquisition unit 13, the monitoring unit 14, the log level change unit 15, the log control unit 16, the log recording unit 17, the change reception unit 18, and the notification unit 19 illustrated in FIG. 2 are stored in the disk 904. Also, the CPU 101 may read various programs from the disk 904, deploy the programs on the memory 102 as processes, and execute the deployed processes to acquire information useful for the investigation into the cause of the fault more appropriately. That is, cooperation between the computation nodes allows the log level of each computation node in the information processing system to be appropriately changed according to the load of system. Accordingly, information on the investigation into the cause of the fault may be efficiently acquired. Further, functionality of each embodiment may be equipped also in the information processing system that uses the virtual adjacency relationship as in the embodiment described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a plurality of information processing apparatuses, each including:
a plurality of resources;
a processor configured:
to acquire an operation history of at least one resource among the plurality of resources,
to monitor a first state of the at least one resource among the plurality of resources;
to notify other information processing apparatuses physically or logically associated with the each information processing apparatus of first control information when the first state of the monitored at least one resource exceeds a threshold value, and
to increase a degree of detail for the acquired operation history when the first state of the at least one resource exceeds the threshold value or second control information is notified from the other information processing apparatuses; and
a memory coupled to the processor, configured to store the operation history.

2. The system of claim 1, wherein
the processor of each information apparatus is configured to increase the degree of detail for acquiring the operation history by increasing a number of types of information to be acquired for the operation history .

3. The system of claim 1, wherein
the processor is configured to increase the degree of detail for acquiring the operation history by shortening an interval of acquiring information for the operation history.

4. The system of claim 1, wherein
the processor is configured to decrease the degree of detail for acquiring the operation history after a predetermined time has elapsed since the degree of detail for acquiring the operation history was increased.

5. The system of claim 1, wherein
the each information processing apparatus is directly connected, via direct connection, to a predetermined number of the other information processing apparatuses and all the plurality of information processing apparatuses are connected with each other via the direct connection or via indirect connection mediated by the other information processing apparatuses; and
the processor is configured to notify the each information processing apparatus and the predetermined number of other information processing apparatuses directly connected to the each information processing apparatus of the first control information.

6. The system of claim 1, wherein
a single process is allocated to a set of information processing apparatuses including the each information processing apparatus, and
the processor is configured to notify information processing apparatuses that are included in the set of information processing apparatuses and different from the each information processing apparatus.

7. The system of claim 5, wherein
the each information processing apparatus further includes a data transmission apparatus configured to relay communications between the each information processing apparatus and an external apparatus; and
the processor is configured to notify the data transmission apparatus of the first control information.

8. The system of claim 1, wherein
the processor is configured to notify an information processing apparatus included in a set of information processing apparatuses that are each selected as a virtually adjacent apparatus for the each information processing apparatus of the first control information.

9. The system of claim 1, wherein
the processor is configured to monitor a use rate of a memory as the first state of the at least one resource among the plurality of resources.

10. The system of claim 1, wherein
the processor is configured to monitor a use rate of a CPU as the first state of the at least one resource among the plurality of resources.

11. The system of claim 1, wherein
the processor is configured to monitor, as the first state of the at least one resource among the plurality of resources, a use rate of an input/output unit that performs inputting and outputting of data between the each information processing apparatus and the external apparatus other than the other information processing apparatuses.

12. The system of claim 1, wherein
the monitoring unit is configured to monitor, as the first state of the at least one resource among the plurality of resources, a use rate of a network that connects the each information apparatus with the other information processing apparatuses.

13. The system of claim 1, wherein
the monitoring unit is configured to monitor, as the first state of the at least one resource among the plurality of resources, an amount of OS jitter indicating a number of times of interruption that stops a computation process for the OS.

14. A method of an system including a plurality of information processing apparatuses, the method comprising:
causing each information processing apparatus to acquire an operation history of at least one resource in a plurality of resources provided for the each information processing apparatus;
causing the each information processing apparatus to monitor a state of the at least one resource among the plurality of resources;
when the state of the at least one resource exceeds a threshold value, causing the each information processing apparatus to notify other information processing apparatuses physically or logically associated with the each information processing apparatus of control information; and
causing the each information processing apparatus to increase a degree of detail for acquiring the operation history of the each information processing apparatus; and
causing each of the other information processing apparatuses that have been notified of the control information from the each information processing apparatus to increase a degree of detail for acquiring an operation history of the each of the other information processing apparatuses.

15. A non-transitory, computer-readable recording medium having stored therein a program for causing a computer included in an information processing apparatus including a plurality of resources to execute a process comprising:
acquiring an operation history of at least one resource in the plurality of resources;
monitoring a state of the at least one resource among the plurality of resources;
notifying other information processing apparatuses physically or logically associated with the information processing apparatus of first control information when the state of the at least one resource exceeds a threshold value; and
increasing a degree of detail for acquiring the operation history of the information processing apparatus when the state of the at least one resource exceeds a threshold value or when second control information is notified from the other information processing apparatuses.
